(19) United States
(12) Patent Application Publication
(10) Pub. No.: US 2019/0182811 A1
(43) Pub. Date: Jun. 13, 2019

(54) METHOD AND DEVICE FOR RESOURCE INDICATION, METHOD AND DEVICE FOR RESOURCE DETERMINATION, NETWORK-SIDE DEVICE AND DEVICE AT RECEIVING SIDE

(71) Applicants: China Mobile Communication Ltd., Research Institute, Beijing (CN); China Mobile Communications Corporation, Beijing (CN)

(72) Inventor: Xiaodong Xu, Beijing (CN)

(21) Appl. No.: 16/327,276

(22) PCT Filed: Aug. 18, 2017
(86) PCT No.: PCT/CN2017/098127

§ 371 Date: Feb. 21, 2019

(30) Foreign Application Priority Data
Aug. 22, 2016 (CN) 201610703650.1

(51) Int. Cl. H04W 72/04; H04W 72/12

(52) U.S. Cl. CPC H04W 72/042; H04W 72/1268; H04W 72/0446

(57) ABSTRACT

A method and a device for resource indication, a method and a device for resource determination, a network-side device and a device at a receiving side are provided. The method for resource indication includes: transmitting resource indication information to a device at a receiving side. The resource indication information is used to indicate the device at the receiving side to determine, from consecutive time-domain resources repeated in a first periodicity and corresponding to a full configuration mode, a part or all of the time-domain resources as radio transmission resources for interaction with the network-side device.

### CROSS-REFERENCE TO RELATED APPLICATION

This application claims a priority to Chinese Patent Application No. 201610703650.1 filed on Aug. 22, 2016, the disclosure of which is incorporated in its entirety by reference herein.

### TECHNICAL FIELD

The present disclosure relates to the field of resource configurations in a mobile communication system, in particular to a method and a device for resource indication, a method and a device for resource determination, a network-side device and a device at a receiving side, which may enable a flexible resource configuration.

### BACKGROUND

Frame structure applicable to a Long Time Evolution (LTE) Time Division Duplexing (TDD) system in related art is schematically illustrated in FIG. 1. In the TDD system, uplink and downlink transmission may occupy different subframes or different slots on same frequency. In FIG. 1, each radio frame has a length of 10 ms and consists of two half-frames with a length of 5 ms. Each half-frame consists of five subframes with a length of 1 ms. There are three different types of subframes in FIG. 1. downlink subframes, uplink subframes and special subframes. Each special subframe consists of three parts, i.e. Downlink Pilot Time Slot (DwPTS), Guard Period (GP) and Uplink Pilot Time Slot (UpPTS). Each half-frame consists of at least one downlink subframe, at least one uplink subframe and at least one special subframe.

In the related art, a uplink-downlink slot configuration (shown in the table 1 below as Table 4.2-2 provided in 3GPP TS 36.211) and a GP configuration (shown in the table 2 below as Table 4.2-1 provided in 3GPP TS 36.211) considering a cell radius as a main design factor are pre-defined by the LTE TDD system.

TABLE 1

| Uplink- | Downlink- | | | | | | | | | | |
|---|---|---|---|---|---|---|---|---|---|---|---|
| downlink | to-Uplink | | | | | | | | | | |
| Config- | Switch- | | | | | | | | | | |
| uration | point | Subframe number | | | | | | | | | |
| mode | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

TABLE 2

| | Normal cyclic prefix in | | | Extended cyclic prefix in | | |
|---|---|---|---|---|---|---|
| | downlink | | | downlink | | |
| | | UpPTS | | | UpPTS | |
| Special | | Normal | Extended | | Normal | Extended |
| subframe | | cyclic | cyclic | | cyclic | cyclic |
| Configuration | | prefix in | prefix in | | prefix in | prefix in |
| mode | DwPTS | uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

As can be seen in Table 1 and Table 2, the existing resource configuration mode is relatively rigid and fails to fulfil requirements.

### SUMMARY

Embodiments of the present disclosure is to provide a method and a device for resource indication, a method and a device for resource determination, a network-side device and a device at a receiving side, to achieve a flexible resource configuration.

In view of the above, the embodiments of the present disclosure provide a method for resource indication applied in a network-side device. The method includes: transmitting resource indication information to a device at a receiving side, where the resource indication information is used to indicate the device at the receiving side to determine, from consecutive time-domain resources repeated in a first periodicity and corresponding to a full configuration mode, a part or all of the time-domain resources as radio transmission resources for interaction with the network-side device.

Preferably, the resource indication information is used to indicate quantity information and location information related to the radio transmission resources.

Preferably, the radio transmission resources are continuously distributed in a time domain.

Preferably, the resource indication information includes a location of a starting point of the radio transmission resources in the consecutive time-domain resources and the quantity of basic time scheduling units contained in the radio transmission resources.

Preferably, the first periodicity is a repeat cycle of radio frames in a mobile communication system, a repeat cycle of uplink basic time scheduling units in a Time Division Duplex (TDD) mobile communication system, a repeat cycle of a synchronization signal in the mobile communication system, or an occurrence cycle of the uplink basic time scheduling units.

Preferably, the method further includes: transmitting the full configuration mode to the device at the receiving side, where the full configuration mode is used for the device at the receiving side to determine the consecutive time-domain resources repeated in the first periodicity.

Preferably, the full configuration mode includes:

a periodicity parameter, used to describe the first periodicity; or

a resource structure parameter, used to describe a structure of the consecutive time-domain resources; or

a resource configuration parameter, used to describe configuration information about forming the consecutive time-domain resources.

Preferably, the consecutive time-domain resources repeated in the first periodicity and corresponding to the full configuration mode are pre-agreed by the network-side device with the device at the receiving side.

Preferably, the method further includes: transmitting transmission result indication information to the device at the receiving side, to indicate the device at the receiving side whether to receive the resource indication information, where the transmission result indication information is used to indicate whether the resource indication information has been transmitted.

The embodiments of the present disclosure further provide a method for resource determination, applied in a device at a receiving side. The method includes: determining, based on resource indication information, a part or all of time-domain resources from consecutive time-domain resources repeated in a first periodicity and corresponding to a full configuration mode, as radio transmission resources for interaction with a network-side device, when the resource indication information is received from the network-side device.

Preferably, the resource indication information is used to indicate quantity information and location information related to the radio transmission resources.

Preferably, the radio transmission resources are continuously distributed in a time domain.

Preferably, the resource indication information includes a location of a starting point of the radio transmission resources in the consecutive time-domain resources and the quantity of basic time scheduling units contained in the radio transmission resources.

Preferably, the first periodicity is a repeat cycle of radio frames in a mobile communication system, a repeat cycle of uplink basic time scheduling units in a TDD mobile communication system, a repeat cycle of a synchronization signal in the mobile communication system, or an occurrence cycle of the uplink basic time scheduling units.

Preferably, the method further includes:

receiving the full configuration mode from the network-side device; and

determining, based on the full configuration mode, the consecutive time-domain resources repeated in the first periodicity.

Preferably, the full configuration mode includes:

a periodicity parameter, used to describe the first periodicity; or

a resource structure parameter, used to describe a structure of the consecutive time-domain resources; or

a resource configuration parameter, used to describe configuration information about forming the consecutive time-domain resources.

Preferably, the consecutive time-domain resources repeated in the first periodicity and corresponding to the full configuration mode are pre-agreed by the network-side device with the device at the receiving side.

Preferably, the method further includes: selecting the consecutive time-domain resources as the radio transmission resources for interaction with the device at a network side, when no resource indication information has been received from the network-side device, or when transmission result indication information is received from the network-side device and the transmission result indication information indicates that no resource indication information has been transmitted.

The embodiments of the present disclosure further provide a device for resource indication, applied in a network-side device. The device includes a first transmitting module, configured to transmit resource indication information to a device at a receiving side, where the resource indication information is used to indicate the device at the receiving side to determine, from consecutive time-domain resources repeated in a first periodicity and corresponding to a full configuration mode, a part or all of the time-domain resources as radio transmission resources for interaction with the network-side device.

Preferably, the resource indication information is used to indicate quantity information and location information related to the radio transmission resources.

Preferably, the radio transmission resources are continuously distributed in a time domain.

Preferably, the resource indication information includes a location of a starting point of the radio transmission resources in the consecutive time-domain resources and the quantity of basic time scheduling units contained in the radio transmission resources.

Preferably, the first periodicity is a repeat cycle of radio frames in a mobile communication system, a repeat cycle of uplink basic time scheduling units in a TDD mobile communication system, a repeat cycle of a synchronization signal in a mobile communication system, or an occurrence cycle of the uplink basic time scheduling units.

Preferably, the device further includes: a second transmitting module, configured to transmit the full configuration mode to the device at the receiving side, where the full configuration mode is used for the device at the receiving side to determine the consecutive time-domain resources repeated in the first periodicity.

Preferably, the full configuration mode includes:

a periodicity parameter, used to describe the first periodicity; or

a resource structure parameter, used to describe a structure of the consecutive time-domain resources; or

a resource configuration parameter, used to describe configuration information about forming the consecutive time-domain resources.

Preferably, the consecutive time-domain resources repeated in a first periodicity and corresponding to the full configuration mode are pre-agreed by the network-side device with the device at the receiving side.

Preferably, the device further includes: a third transmitting module, configured to transmit transmission result indication information to the device at the receiving side, to indicate the device at the receiving side whether to receive the resource indication information, where the transmission result indication information is used to indicate whether the resource indication information has been transmitted.

The embodiments of the present disclosure further provide a device for resource determination, applied in a device at the receiving side. The device includes: a first determining module, configured to determine, based on resource indication information, a part or all of time-domain resources from consecutive time-domain resources repeated in a first periodicity and corresponding to a full configuration mode, as radio transmission resources for interaction with a network-side device, when the resource indication information is received from the network-side device.

Preferably, the resource indication information is used to indicate quantity information and location information related to the radio transmission resources.

Preferably, the radio transmission resources are continuously distributed in a time domain.

Preferably, the resource indication information includes a location of a starting point of the radio transmission resources in the consecutive time-domain resources and the quantity of basic time scheduling units contained in the radio transmission resources.

Preferably, the first periodicity is a repeat cycle of radio frames in a mobile communication system, a repeat cycle of uplink basic time scheduling units in a TDD mobile communication system, a repeat cycle of a synchronization signal in the mobile communication system, or an occurrence cycle of the uplink basic time scheduling units.

Preferably, the device further includes:

a receiving module, configured to receive the full configuration mode from the network-side device; and

a second determining module, configured to determine the consecutive time-domain resources repeated in the first periodicity based on the full configuration mode.

Preferably, the full configuration mode includes:

a periodicity parameter, used to describe the first periodicity; or

a resource structure parameter, used to describe a structure of the consecutive time-domain resources; or

a resource configuration parameter, used to describe configuration information about forming the consecutive time-domain resources.

Preferably, the consecutive time-domain resources repeated in the first periodicity and corresponding to the full configuration mode are pre-agreed by the network-side device and the device at the receiving side.

Preferably, the device further includes: a selecting module, configured to select the consecutive time-domain resources as the radio transmission resources for interaction with the device at the network side, when no resource indication information has been received from a network-side device, or when transmission result indication information is received from the network-side device, and the transmission result indication information indicates that no resource indication information has been transmitted.

The embodiments of the present disclosure further provide a network-side device, including the above device for resource indication.

The embodiments of the present disclosure further provide a device at a receiving side, including the above device for resource determination.

The embodiments of the present disclosure further provide a device for resource indication, applied in a network-side device. The device includes a processor, a memory and a transmitter. The processor is configured to generate resource indication information by calling and executing programs and data stored in the memory. The transmitter is configured to transmit resource indication information to a device at a receiving side, and the resource indication information is used to indicate the device at the receiving side to determine a part or all of time-domain resources from consecutive time-domain resources repeated in a first periodicity and corresponding to a full configuration mode, as radio transmission resources for interaction with the network-side device.

The embodiments of the present disclosure further provide a device for resource determination, applied in a device at the receiving side, and the device includes a processor, a memory and a receiver. The processor is configured to call and execute programs and data stored in the memory, so as to: determine, based on resource indication information, a part or all of time-domain resources from consecutive time-domain resources repeated in a first periodicity and corresponding to a full configuration mode, as radio transmission resources for interaction with a network-side device, when the receiver receives the resource indication information transmitted by the network-side device.

The embodiments of the present disclosure further provide a computer readable storage medium, storing instructions for executing the following steps: transmitting resource indication information to a device at a receiving side, where the resource indication information is used to indicate the device at the receiving side to determine, from consecutive time-domain resources repeated in a first periodicity and corresponding to a full configuration mode, a part or all of the time-domain resources as radio transmission resources for interaction with a network-side device.

The embodiments of the present disclosure further provide a computer readable storage medium, storing instructions for executing the following steps: determining, based on resource indication information, a part or all of time-domain resources from consecutive time-domain resources repeated in a first periodicity and corresponding to a full configuration mode, as radio transmission resources for interaction with a network-side device, when the resource indication information is received from the network-side device.

Thus, according to the method for resource indication of the embodiments of the present disclosure, the resource indication information is transmitted to the device at the receiving side, the device at the receiving side is able to determine part or all of time-domain resources from the consecutive time-domain resources as the radio transmission resources, and the selected radio transmission resources may be either discretely distributed or continuously distributed in the consecutive time-domain resources, thereby achieving a flexible resource allocation.

### BRIEF DESCRIPTION OF THE DRAWINGS

In order to clearly illustrate technical solutions of embodiments of the present disclosure, the drawings of the embodiments of the present disclosure will be briefly described below. It is obvious that the described drawings are only related to some embodiments and thus are not limitative of the present disclosure, and persons skilled in the art may derive other drawings from the drawings without making creative efforts.

FIG. 1 is a flowchart of a method for resource indication according to a first embodiment of the present disclosure.

FIG. 2 is an architecture diagram of a mobile communication system in related art.

FIG. 3 is a schematic diagram illustrating a first distribution of radio transmission resources in a time domain according to an embodiment of the present disclosure.

FIG. 4 is a schematic diagram illustrating a second distribution of radio transmission resources in a time domain according to an embodiment of the present disclosure.

FIG. 5 is a schematic diagram illustrating a third distribution of radio transmission resources in a time domain according to an embodiment of the present disclosure.

FIG. 6 is a schematic diagram illustrating a fourth distribution of radio transmission resources in a time domain according to an embodiment of the present disclosure.

FIG. 7 is a schematic diagram illustrating a fifth distribution of radio transmission resources in a time domain according to an embodiment of the present disclosure.

FIG. 8 is a schematic diagram illustrating a sixth distribution of radio transmission resources in a time domain according to an embodiment of the present disclosure.

FIG. 9 is a flowchart of a method for resource determination according to a second embodiment of the present disclosure.

FIG. 10 is a flowchart of a method for resource indication according to a third embodiment of the present disclosure.

FIG. 11 is a flowchart of a method for resource determination according to a fourth embodiment of the present disclosure.

### DETAILED DESCRIPTION

To make objectives, technical solutions and advantages of the present disclosure clearer, the present disclosure will be described below in combination with the drawings and specific embodiments in detail. In the following description, specific details such as specific configuration and components are merely to facilitate a fully understanding of the embodiments of the present disclosure. Therefore, it will be apparent to those skilled in the art that various modifications and amendments can be made to the embodiments described herein without departing from the scope and the spirit of the present disclosure. Furthermore, in order to make the specification clearer and simpler, detailed description about functions and structures well known in the art will be omitted.

It should be understood that “an embodiment” or “a first embodiment” mentioned in the whole specification mean that particular features, structures, or characteristics related to the embodiment are included in at least one embodiment of the present disclosure. Therefore, “in an embodiment” or “in a first embodiment” appearing throughout the specification may not necessarily refer to a same embodiment. In addition, these particular features, structures, or characteristics may be combined in one or more embodiments in any appropriate manner.

It should be understood that, a value of a sequence number of the following processes does not indicate an execution sequence, and an execution sequence of each process depends on its function and internal logic, which shall not constitute any limitation to an implementation process of the embodiments of the present disclosure.

Moreover, such terms as “system” and “network” may be used interchangeably in this specification.

It should be understood that, the term “and/or” in this specification describes only an association relationship for describing associated objects and represents that three relationships may exist. For example, A and/or B may represent the following three cases: only A exists, both A and B exist, and only B exists. In addition, the character “/” in this specification generally indicates an “or” relationship between the associated objects.

In the embodiments of the present disclosure, generally, the network-side device is a base station without limitation on forms, it may be a Macro Base Station, a Pico Base Station, a 3G mobile base station (Node B), an enhanced Node B (eNB), a home enhanced Node B (referred to as a Femto eNB or Home eNode B or Home eNB or HeNB), a relay base station, an access point, a Remote Radio Unit (RRU), a Remote Radio Head (RRH), and the like. The receiving device may be a relay (Relay) base station, or a mobile phone (or cell phone) or any other device capable of transmitting or receiving a wireless signal, including User Equipment (UE), a Personal Digital Assistant (PDA), a wireless modem, a wireless communication apparatus, a handheld apparatus, a laptop, a cordless telephone, a Wireless Local Loop (WLL) station, a Customer Premise Equipment (CPE), or a mobile intellectual hotspot capable of converting mobile signal into WiFi signal, a smart appliance, or any other device capable of communicating with a mobile communication network voluntarily without human operations.

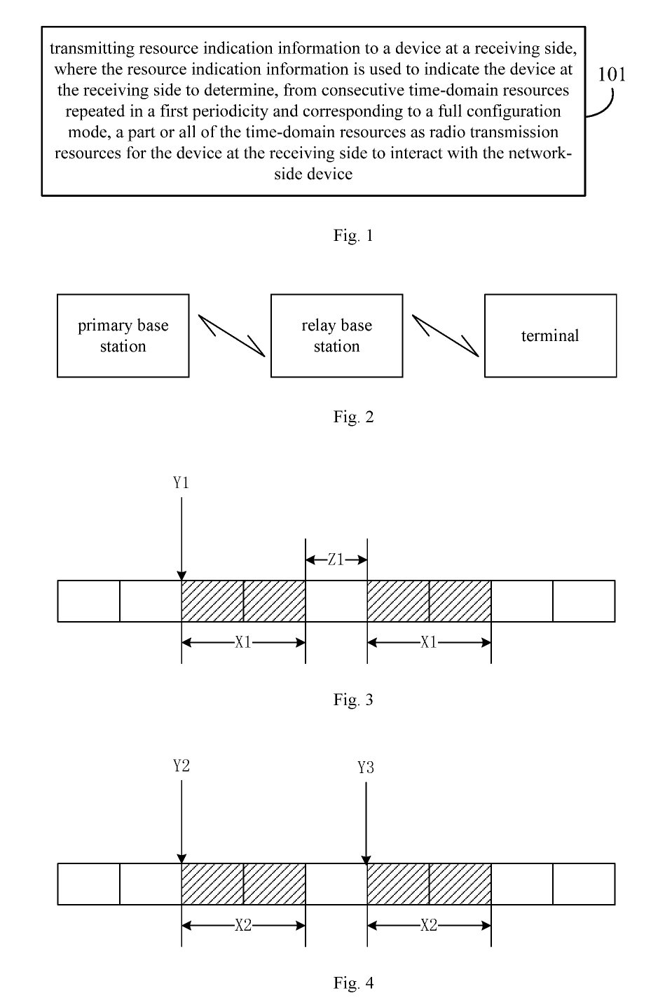

Referring to FIG. 1, a method for resource indication is provided according to an embodiment of the present disclosure, which is applied in a network-side device. The method for resource indication includes step 101:

transmitting resource indication information to a device at a receiving side, where the resource indication information is used to indicate the device at the receiving side to determine, from consecutive time-domain resources repeated in a first periodicity and corresponding to a full configuration mode, a part or all of the time-domain resources as radio transmission resources for the device at the receiving side to interact with the network-side device.

Thus, based on the method for resource indication of the embodiment of the present disclosure, by transmitting the resource indication information to the device at the receiving side, a device at the receiving side can determine a part or all of the time-domain resources, from the consecutive time-domain resources, as the radio transmission resources, and the selected radio transmission resources may be either discretely distributed or continuously distributed from the consecutive time-domain resources, thereby achieving a flexible resource allocation.

Architecture of a typical mobile communication system in related art is as shown in FIG. 2, and a primary base station, a relay base station and a terminal are connected via a mobile communication network. For the relay base station, it may be treated as a “terminal side device” with respect to the primary base station, and it may be treated as a “network-side device” with respect to the terminal. The relay base station may be able to interact with the primary base station by using a first part of the consecutive time-domain resources, while interact with the terminal by using a second part of the consecutive time-domain resources, by using the method of the embodiment of the present disclosure.

Certainly, there may also be another case that the relay base station interacts with the primary base station through the first part of the consecutive time-domain resources, and interacts with the terminal through the second part of the consecutive time-domain resources, while the primary base station interacts with the terminal though a third part of the consecutive time-domain resources.

If the relay base station interacts with the primary base station and the terminal simultaneously by using all of the consecutive time-domain resources, and receiving and transmitting data at same time in certain subframes may be expected. For example, Physical Downlink Control Channel (PDCCH) information from a Donor base station (primary base station) requires to be listened and to be forwarded both in a subframe header, which adversely affects transmission quality. Alternatively, both the primary base station and the relay base station transmit synchronization signals at a same location in a subframe, which adversely affects synchronization of the relay base station and detection of synchronization signal for the terminal. However, according to the method of the embodiments of the present disclosure, the above problems may be avoided, and transmission quality may be increased.

Furthermore, for a general network architecture, “Almost Blank Subframes (ABS)” may be formed in the time-domain resources by using the method of the embodiments of the present disclosure, to implement better interference elimination in a system with a high interference elimination requirement.

In the embodiments of the present disclosure, the resource indication information may be used to indicate quantity information and location information related to the radio transmission resources. It should be noted that, the quantity information and location information related to the radio transmission resources may not be necessarily included in the resource indication information, but must be indicated by the resource indication information.

The resource indication information may include segmentation information, starting point information and/or ending point information, which are used to indicate the quantity information and the location information related to the radio transmission resources.

The radio transmission resources may be either discretely distributed or continuously distributed in the consecutive time-domain resources, and thus a manner for indicating the radio transmission resources will be described hereinafter from both discrete distribution and continue distribution perspective, respectively.

(1) Radio Transmission Resources are Discretely Distributed in the Time Domain.

In the case that the radio transmission resources are discretely distributed in the time domain, there may be several manners for indicating radio transmission resource distribution in the time domain, for example, a first manner, a second manner and a third manner.

The First Manner

In the first manner, radio transmission resources are evenly segmented in the time domain. The resource indication information may include segmentation information and starting point information.

For instance, referring to FIG. 3, the segmentation information, in the time domain, may be the quantity of segments of the radio transmission resources (not shown in FIG. 3), a segmentation interval (Z1) and the quantity of basic time scheduling units contained in each segment (X1), and the starting point information may be a starting point (Y1) of the radio transmission resources.

For another instance, referring to FIG. 4, the segmentation information, in the time domain, may be the quantity of the basic time scheduling units contained in each segment (X2), and the starting point information may be starting points (Y1, Y3) of transmission resources of the segments.

The Second Manner

In the second manner, radio transmission resources are unevenly segmented in the time domain. The resource indication information may include segmentation information and starting point information.

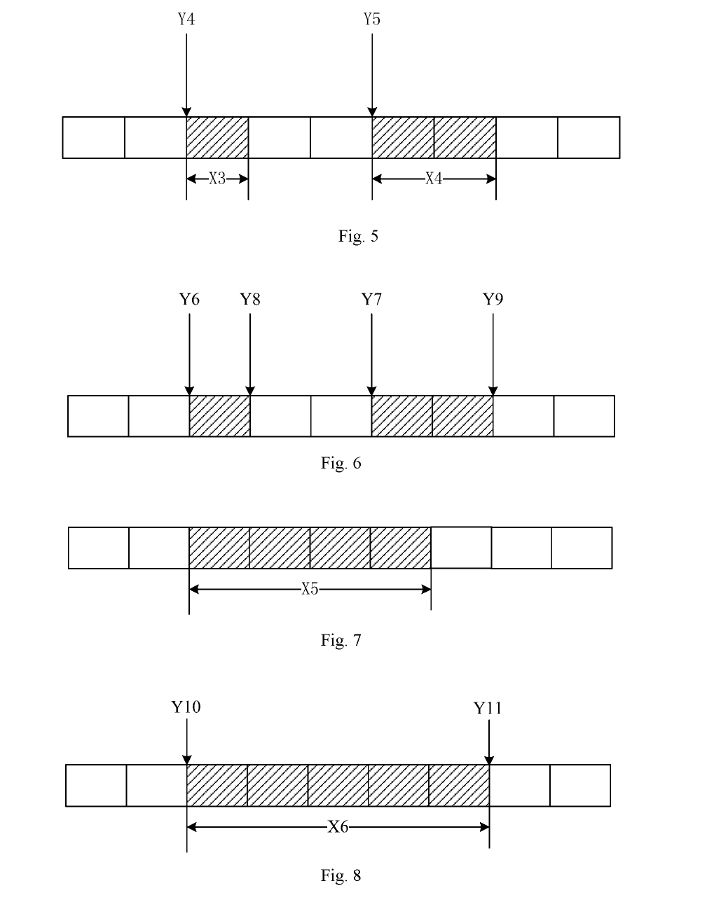

For instance, referring to FIG. 5, the segmentation information, in the time domain, may be the quantity of basic time scheduling units contained in each segment (X3, X4), and the starting point information may be starting points (Y4, Y5) of transmission resources of the segments.

The Third Manner

In the third manner, radio transmission resources are unevenly segmented in the time domain. The resource indication information may include starting point information and ending point information.

For instance, referring to FIG. 6, the starting point information may be starting points (Y6, Y7) of transmission resources of the segments, and the ending point information may be ending points (Y8, Y9) of transmission resources of the segments.

(2) Radio Transmission Resources are Continuously Distributed in the Time Domain.

In the case that the radio transmission resources are continuously distributed in the time domain, there may be several manners for indicating radio transmission resource distribution in the time domain, for example, a first mode, a second mode, and a third mode described below.

The First Mode

In the first mode, the starting point or the ending point may be default, and the resource indication information may only include segmentation information.

For instance, referring to FIG. 7, the segmentation information, in the time domain, may be the quantity of basic time scheduling units contained in the radio transmission resources (X5).

Parameter design can be simplified in the first mode, as only one parameter is needed.

The Second Mode

In the second mode, the resource indication information may include segmentation information and starting point information (or ending point information).

For instance, referring to FIG. 8, the segmentation information, in the time domain, may be the quantity of basic time scheduling units contained in the radio transmission resources (X6), and the starting point information may be a starting point (Y10) of the radio transmission resources, or the ending point information may be a starting point (Y11) of the radio transmission resources.

In the first mode, any continuous part of the time-domain resources may be assigned flexibly, thereby improving the flexibility of resource allocation.

It should be noted that, each of the above basic time scheduling units may be a basic time scheduling unit in the time domain, for example, a transmission time interval (TTI), or the smallest time scheduling unit (an OFDM symbol), or other time-domain units larger or smaller than the TTI in LTE system in related art, which are not limited in the present disclosure.

In terms of data included in the above resource indication information, when the radio transmission resources are discretely distributed in the time domain, the resource indication information may at least include more than three fields. The more segments which the radio transmission resources are segmented into are, the more fields included in the resource indication information are. While the radio transmission resources are continuously distributed in the time domain, only two fields may be enough to indicate the number and distribution of the radio transmission resources. Therefore, compared with the case that the radio transmission resources are discretely distributed in the time domain, the system overhead may be reduced in a case that the radio transmission resources are continuously distributed in the time domain.

Therefore, in order to reduce the system overhead, it's preferred that the radio transmission resources are continuously distributed in the time domain in the embodiments of the present disclosure.

In the case that the radio transmission resources are continuously distributed in the time domain, the resource indication may be only the offset of a starting point of the radio transmission resources relative to a starting point of the consecutive time-domain resources, which may indicate the quantity information and the location information related to the consecutive time-domain resources. Alternatively, the resource indication information may be a location of a starting point of the radio transmission resources in the consecutive time-domain resources and the quantity of basic time scheduling units contained in the radio transmission resources.

In a specific embodiment of the present disclosure, the first periodicity may be a repeat cycle of radio frames in a mobile communication system, a repeat cycle of uplink basic time scheduling units in a TDD mobile communication system, a repeat cycle of a synchronization signal in a mobile communication system, or an occurrence cycle of the uplink basic time scheduling units, and the like, which is not limited in the present disclosure.

It should be noted that, the basic time scheduling unit in LTE system here may be a subframe having a length of 1 ms, and it may also be other units having a shorter duration, such as a subframe having a duration of 0.5 ms, or may even be an OFDM symbol.

In a specific embodiment of the present disclosure, the method for resource indication may further include: transmitting the full configuration mode to the device at the receiving side. The full configuration mode may be used in determining the consecutive time-domain resources repeated in the first periodicity by the device at the receiving side.

The full configuration mode may include: a periodicity parameter used to describe the first periodicity, or a resource structure parameter, or a resource configuration parameter.

The resource structure parameter may be used to describe a structure of the consecutive time-domain resources.

The resource configuration parameter may be used to describe configuration information about forming the consecutive time-domain resources.

For example, the structure of the consecutive time-domain resources described by the resource structure parameter may be as shown in the following table 1:

TABLE 1
Subframe Number

| 0 | 1 | 2 | 3 | 4 | 5 | 6 | 7 | 8 | 9 |
|---|---|---|---|---|---|---|---|---|---|
| D | S | U | U | U | D | D | D | D | D |

For another example, the configuration information described by the resource configuration parameter may be as followed: the consecutive time-domain resources include ten subframes, the proportion of the number of uplink subframes, the number of downlink subframes and the number of special subframes is 4:2:4, the uplink subframes are between two special subframes, and the first subframe and the sixth subframe are the two special subframes. Accordingly, the structure of the consecutive time-domain resources as shown in the following table 2 can be formed based on the foregoing configuration information.

TABLE 2
Subframes Number

| 0 | 1 | 2 | 3 | 4 | 5 | 6 | 7 | 8 | 9 |
|---|---|---|---|---|---|---|---|---|---|
| D | S | U | U | U | U | S | D | D | D |

It should be noted that, the foregoing is merely an example of how to determine the periodicity of consecutive time-domain resources and the type of subframes from resource configuration parameters, and the present disclosure is not limited to the foregoing particular subframe structure.

Certainly, the less the indication information is, the less the system overhead is required. Therefore, in a specific embodiment of the present disclosure, which parameters may be applied to the full configuration mode can be decided according to actual applications.

Additionally, in a specific embodiment of the present disclosure, the consecutive time-domain resources repeated in the first periodicity and corresponding to the full configuration mode may also be defined by a network-side device and a device at the receiving side.

In a specific embodiment of the present disclosure, the transmitting the resource indication information may indicate that the receiving side requires to determine the transmission resources based on the resource indication information, and for the network side, it may be determined, in accordance with the resource indication information, whether or not the transmission resources will be selected.

In a specific embodiment of the present disclosure, indication information about a transmission result may also be transmitted by the network side. When the indication information about the transmission result indicates that the resource indication information has been transmitted, it is necessary for the device at the receiving side to detect and receive the resource indication information. When the indication information about the transmission result indicates that no resource indication information has been transmitted, the device at the receiving side may determine directly the consecutive time-domain resources as the radio transmission resources for interaction with the network-side device, instead of detecting and receiving resource indication information.

In this manner, the method for resource indication according to the embodiments of the present disclosure may further include: transmitting, to the device at the receiving side, transmission result indication information that indicates whether the resource indication information has been transmitted, to indicate the device at the receiving side whether to receive the resource indication information or not.

When the transmission result indication information indicates that the resource indication information has been transmitted, the device at the receiving side receives the resource indication information, and determines the radio transmission resources based on the resource indication information. When the transmission result indication information indicates that no resource indication information has been transmitted, the device at the receiving side directly determines the consecutive time-domain resources as the radio transmission resources for the device at the receiving side to interact with the network-side device.

The transmission result indication information may be transmitted by a base station through high-layer signaling and/or downlink control information. A mobile communication terminal is taken as an example as followed.

First Manner: Configuration Through High-Layer Signaling

In the case that a terminal is able to support the ability of determining part or all of time-domain resources from the consecutive time-domain resources as the radio transmission resources (hereinafter referred to as a resource selection mode), whether to transmit the resource indication information may be configured by a high layer signaling for the terminal.

If it has been configured by the high-layer signaling to transmit the resource indication information for the terminal, the resource selection mode is adopted in transmission directly by the terminal, according to the high-layer signaling.

Second Manner: Configuration Through Physical Layer Dynamic Control Information

In the case that base station may be aware of that a terminal is able to support the ability of determining part or all of time-domain resource from the consecutive time-domain resources as the radio transmission resources (hereinafter referred to as resource selection mode), a scheduling indication information bit may be added to downlink control information by adding a new bit or by using a reserved field, which indicates that the resource selection mode is to be adopted in transmission this time.

For example, the scheduling indication bit is added, if the bit is 1, it may indicate that the resource selection mode is to be adopted in transmission, i.e. resource indication information has been transmitted; and if the bit is 0, it may indicate that the resource selection mode is not to be adopted in transmission, i.e. no resource indication information has been transmitted. Alternatively, if the bit is 0, it may indicate that the resource selection mode is to be adopted in transmission; and if the bit is 1, it may indicate that the resource selection mode is not to be adopted in transmission.

Specifically, with respect to a terminal with the above ability, control information including the above scheduling indication may be used at network side, while with respect to a terminal without the above ability, existing protocol may be used.

At the terminal side, the foregoing downlink physical layer dynamic control information including the scheduling indication may be detected by a terminal with the foregoing ability, and whether the resource selection mode is to be adopted in transmission may be determined based on the value of the scheduling indication bit.

Third, joint configuration through high-layer signaling and physical layer dynamic control information

The third manner is a combination of the first manner and the second manner. The high-layer signaling configuration and dynamic indication may be performed simultaneously at the network side. For the terminal that supports the foregoing ability, the foregoing downlink physical dynamic control information including the scheduling indication may further be detected, if it has been configured, through high-layer signaling, that resource selection mode is to be used in transmission, and the type of current scheduling may be determined based on the value of scheduling indication bit.

If it has been configured, through the high-layer signaling, that the resource selection mode is not to be adopted in transmission, existing protocol may be used.

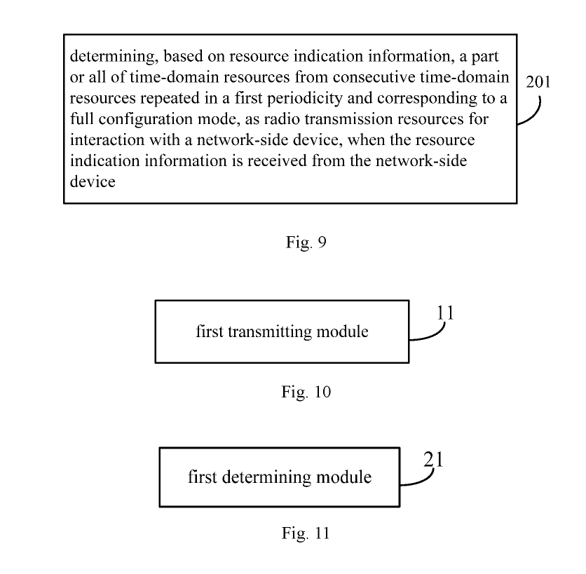

Referring to FIG. 9, a method for resource determination is provided according to a second embodiment of the present disclosure, which is applied in a device at a receiving side. The method for resource determination may include step 201:

determining, based on resource indication information, a part or all of time-domain resources from consecutive time-domain resources repeated in a first periodicity and corresponding to a full configuration mode, as radio transmission resources for interaction with a network-side device, when the resource indication information is received from the network-side device.

Therefore, based on the method for resource indication of the embodiment of the present disclosure, a flexible resource allocation can be achieved by determining part or all of time-domain resources, from the consecutive time-domain resources repeated in the first periodicity and corresponding to the full configuration mode, as the radio transmission resources for interaction with the network-side device, based on the resource indication information received from the network-side device. The selected radio transmission resources may be either discretely distributed or continuously distributed in the consecutive time-domain resources.

In a specific embodiment of the present disclosure, the resource indication information may be used to indicate quantity information and location information related to the consecutive time-domain resources.

In order to reduce the system overhead, it is preferred that radio transmission resources are continuously distributed in the time domain.

Specifically, the resource indication information may include a location of a starting point of the radio transmission resources in the consecutive time-domain resources and the quantity of basic time scheduling units contained in the radio transmission resources.

It should be understood that, the above location of the starting point of the radio transmission resources in the consecutive time-domain resources may be:

a relative location, for example, the resource indication information being the offset of the starting point of the radio transmission resources relative to the starting point of the consecutive time-domain resources; or

an absolute location, such as serial numbers of subframes.

In a specific embodiment of the present disclosure, the first periodicity may be a repeat cycle of radio frames in a mobile communication system, a repeat cycle of uplink basic time scheduling units in a TDD mobile communication system, a repeat cycle of a synchronization signal in a mobile communication system, or an occurrence cycle of the uplink basic time scheduling units, and the like, which is not limited in the present disclosure.

In a specific embodiment of the present disclosure, the method for resource determination may further include:

receiving the full configuration mode from the network-side device; and

determining, based on the full configuration mode, the consecutive time-domain resources repeated in the first periodicity.

The full configuration mode may include: a periodicity parameter, or a resource structure parameter, or a resource configuration parameter.

The periodicity parameter may be used to describe the first periodicity.

The resource structure parameter may be used to describe a structure of the consecutive time-domain resources.

The resource configuration parameter may to describe configuration information about forming the consecutive time-domain resources.

Additionally, in a specific embodiment of the present disclosure, the consecutive time-domain resources repeated in the first periodicity and corresponding to full configuration mode may be pre-agreed by the network-side device with the device at the receiving side. That is, the consecutive time-domain resources repeated in the first periodicity and corresponding to the full configuration mode may be determined based on what has been pre-agreed by the device at the receiving side with the network-side device.

In a specific embodiment of the present disclosure, the method for resource determination may further include:

directly determining the consecutive time-domain resources as the radio transmission resource for the device at the receiving side to interact with the network-side device, when no resource indication information has been received from the network-side device, or when transmission result indication information is received from the network-side device, and the transmission result indication information indicates that no resource indication information has been transmitted.

Referring to FIG. 10, a device for resource indication is provided according to a third embodiment of the present disclosure, which is applied in a network-side device. Corresponding to the method for resource indication as shown in FIG. 1, the device for resource indication may include:

a first transmitting module 11, configured to transmit resource indication information to a device at a receiving side, where the resource indication information is used to indicate the device at the receiving side to determine, from consecutive time-domain resources repeated in a first periodicity and corresponding to a full configuration mode, a part or all of the time-domain resources as radio transmission resources for the device at the receiving side to interact with the network-side device.

In a specific embodiment of the present disclosure, the resource indication information may indicate quantity information and location information related to the consecutive time-domain resources.

In order to reduce the system overhead, it is preferred that the radio transmission resources are continuously distributed in a time domain.

Specifically, the resource indication information includes a location of a starting point of the radio transmission resources in the consecutive time-domain resources and the quantity of basic time scheduling units contained in the radio transmission resources.

In a specific embodiment of the present disclosure, the first periodicity may be a repeat cycle of radio frames in a mobile communication system, a repeat cycle of uplink basic time scheduling units in a TDD mobile communication system, a repeat cycle of a synchronization signal in a mobile communication system, or an occurrence cycle of the uplink basic time scheduling units.

In a specific embodiment of the present disclosure, the device for resource indication may further include: a second transmitting module, configured to transmit the full configuration mode to the device at the receiving side. The full configuration mode may be used in determining the consecutive time-domain resources repeated in the first periodicity by the device at the receiving side.

The full configuration mode may include: a periodicity parameter, or a resource structure parameter, or a resource configuration parameter.

The periodicity parameter may be used to describe the first periodicity.

The resource structure parameter may be used to describe a structure of the consecutive time-domain resources.

The resource configuration parameter may to describe configuration information about forming the consecutive time-domain resources.

Additionally, in a specific embodiment of the present disclosure, the consecutive time-domain resources repeated in the first periodicity and corresponding to full configuration mode may be pre-agreed by the network-side device with the device at the receiving side.

In a specific embodiment of the present disclosure, the device for resource indication may further include: a third transmitting module, configured to transmit transmission result indication information to the device at the receiving side, to indicate the device at the receiving side whether to receive the resource indication information, and the transmission result indication information is used to indicate whether the resource indication information has been transmitted.

Therefore, based on the device for resource indication of the embodiment of the present disclosure, a flexible resource allocation can be achieved by determining a part or all of time-domain resources, from the consecutive time-domain resources repeated in the first periodicity and corresponding to the full configuration mode, as the radio transmission resource for interaction with the network-side device, based on the resource indication information received from the network-side device. The selected radio transmission resources may be either discretely distributed or continuously distributed among the consecutive time-domain resources.

Optionally, a device for resource indication is further provided according to an embodiment of the present disclosure, which is applied in a network-side device. The device includes: a processor, a memory connected with the processor via a bus interface, and a transmitter connected with the processor via a bus interface. The memory may be configured to store programs and data used by the processor when the processor performs an operation.

The processor may be configured to generate resource indication information by calling and executing programs and data stored in the memory. The transmitter may be configured to transmit the resource indication information to a device at a receiving side, and the resource indication information may be used to indicate the device at the receiving side to determine a part or all of time-domain resources, from consecutive time-domain resources repeated in a first periodicity and corresponding to a full configuration mode, as radio transmission resources for the device at the receiving side to interact with the network-side device.

The above embodiments may be referred to for specific implementations, which will not be described herein.

Referring to FIG. 11, a device for resource determination is provided according to a fourth embodiment of the present disclosure, which is applied in a device at a receiving side. Corresponding to the method for resource determination as shown in FIG. 9, the device for resource determination may include: a first determining module 21, configured to determine, based on resource indication information, a part or all of time-domain resources from consecutive time-domain resources repeated in a first periodicity and corresponding to a full configuration mode, as radio transmission resources for interaction with a network-side device, when the resource indication information is received from the network-side device.

In a specific embodiment of the present disclosure, the resource indication information may indicate quantity information and location information related to the consecutive time-domain resources.

In order to reduce system overhead, it is preferred that radio transmission resources are continuously distributed in a time domain.

Specifically, the resource indication information may be a location of a starting point of the radio transmission resources in the consecutive time-domain resources and the quantity of basic time scheduling units contained in the radio transmission resources.

In a specific embodiment of the present disclosure, the first periodicity may be a repeat cycle of radio frames in a mobile communication system, a repeat cycle of uplink basic time scheduling units in a TDD mobile communication system, a repeat cycle of a synchronization signal in the mobile communication system, or an occurrence cycle of the uplink basic time scheduling units.

In a specific embodiment of the present disclosure, the device for resource determination may further include:

a receiving module, configured to receive the full configuration mode from the network-side device; and

a second determining module, configured to determine the consecutive time-domain resources repeated in the first periodicity based on the full configuration mode.

The full configuration mode may include: a periodicity parameter, or a resource structure parameter, or a resource configuration parameter.

The periodicity parameter may be used to describe the first periodicity.

The resource structure parameter may be used to describe a structure of the consecutive time-domain resources.

The resource configuration parameter may be used to describe configuration information used for forming the consecutive time-domain resources.

Additionally, in a specific embodiment of the present disclosure, the consecutive time-domain resources repeated in a first periodicity and corresponding to full configuration mode may be pre-defined by the network-side device and the device at the receiving side.

In a specific embodiment of the present disclosure, the device for resource determination may further include: a selecting module, configured to directly select the consecutive time-domain resources as the radio transmission resources for interaction with the device at the network side, when no resource indication information has been received from a network-side device, or when transmission result indication information is received from the network-side device, and the transmission result indication information indicates that no resource indication information has been transmitted.

Therefore, based on the device for resource determination according to the embodiments of the present disclosure, part or all of time-domain resource are determined, based on the resource indication information received from the network-side device, from the consecutive time-domain resources repeated in the first periodicity and corresponding to the full configuration mode, as the radio transmission resources for interaction with a network-side device. The selected radio transmission resources may be either discretely distributed or continuously distributed from the consecutive time-domain resources. In such a manner, a flexible resource allocation can be achieved

Optionally, a device for resource determination is provided according to an embodiment of the present disclosure, which is applied in a device at a receiving side. The device includes: a processor, a memory connected with the processor via a bus interface, and a receiver connected with a processor via a bus interface. The memory may be configured to store programs and data used by the processor when the processor performs an operation.

The processor may be configured to call and execute programs and data stored in the memory, so as to: determine a part or all of time-domain resource, from consecutive time-domain resources repeated in a first periodicity and corresponding to a full configuration mode, as radio transmission resources for interaction with a network-side device, based on resource indication information, when the resource indication information is received from the network-side device by the receiver.

In addition, a network-side device is further provided according to an embodiment of the present disclosure, including the above-mentioned device for resource indication.

A device at a receiving side is further provided according to an embodiment of the present disclosure, including the above-mentioned device for resource determination.

It should be noted that, such terms as “include”, “comprise”, “contain” or any variations thereof used in the specification are intended to cover a non-exclusive inclusion, and a process, a method, an article, or a device that includes a list of elements not only includes those elements, but may also include other elements that are not expressly listed or may also include other elements that are inherent to such process, method, article, or device. An element defined by “includes a . . . ”, without more constraints, does not preclude the existence of additional identical elements in the process, method, article, or device that includes the element.

The above-mentioned serial numbers of the embodiments of the present disclosure are merely for description, and do not represent advantages and disadvantages of the embodiments.

Based on the foregoing descriptions of the implementations, a person skilled in the art may clearly understand that the methods in the above embodiments may be implemented by means of software and a necessary general hardware platform, and of course, can also be implemented by means of hardware, and the former is preferred in many cases. Based on such understanding, the technical solutions of the present disclosure essentially or the part contributing to the prior art may be implemented in a form of a software product. A computer software product may be stored in a memory medium, such as a read-only memory (ROM), a random access memory (RAM), a magnetic disk, or an optical disc, and includes several instructions for instructing a terminal device (which may be a mobile phone, a personal computer, a server, an air conditioner, a network-side device, or the like) to perform the methods described in the embodiments of the present disclosure.

1. A method for resource indication, applied in a network-side device, comprising:
transmitting resource indication information to a device at a receiving side, wherein the resource indication information is used to indicate the device at the receiving side to determine, from consecutive time-domain resources repeated in a first periodicity and corresponding to a full configuration mode, a part or all of the time-domain resources as radio transmission resources for interaction with the network-side device.

2. The method for resource indication according to claim 1, wherein the resource indication information is used to indicate quantity information and location information related to the radio transmission resources.

3. The method for resource indication according to claim 2, wherein the radio transmission resources are continuously distributed in a time domain, and wherein the resource indication information comprises a location of a starting point of the radio transmission resources in the consecutive time-domain resources and the quantity of basic time scheduling units contained in the radio transmission resources.

4. (canceled)

5. The method for resource indication according to claim 1, wherein the first periodicity is a repeat cycle of radio frames in a mobile communication system, a repeat cycle of uplink basic time scheduling units in a Time Division Duplex (TDD) mobile communication system, a repeat cycle of a synchronization signal in the mobile communication system, or an occurrence cycle of the uplink basic time scheduling units.

6. The method for resource indication according to claim 1, further comprising:
transmitting the full configuration mode to the device at the receiving side, wherein the full configuration mode is used for the device at the receiving side to determine the consecutive time-domain resources repeated in the first periodicity,
wherein the full configuration mode comprises:
a periodicity parameter, used to describe the first periodicity; or
a resource structure parameter, used to describe a structure of the consecutive time-domain resources; or
a resource configuration parameter, used to describe configuration information about forming the consecutive time-domain resources.

7. (canceled)

8. The method for resource indication according to claim 1, wherein the consecutive time-domain resources repeated in the first periodicity and corresponding to the full configuration mode are pre-agreed by the network-side device with the device at the receiving side, or
the method further comprises:
transmitting transmission result indication information to the device at the receiving side, to indicate the device at the receiving side whether to receive the resource indication information, wherein the transmission result indication information is used to indicate whether the resource indication information has been transmitted.

9. (canceled)

10. A method for resource determination, applied in a device at a receiving side, comprising:
determining, based on resource indication information, a part or all of time-domain resources from consecutive time-domain resources repeated in a first periodicity and corresponding to a full configuration mode, as radio transmission resources for interaction with a network-side device, when the resource indication information is received from the network-side device.

11. The method for resource determination according to claim 10, wherein the resource indication information is used to indicate quantity information and location information related to the radio transmission resources.

12. The method for resource determination according to claim 10, wherein the radio transmission resources are continuously distributed in a time domain, and wherein the resource indication information comprises a location of a starting point of the radio transmission resources in the consecutive time-domain resources and the quantity of basic time scheduling units contained in the radio transmission resources.

13. (canceled)

14. The method for resource determination according to claim 10, wherein the first periodicity is a repeat cycle of radio frames in a mobile communication system, a repeat cycle of uplink basic time scheduling units in a TDD mobile communication system, a repeat cycle of a synchronization signal in the mobile communication system, or an occurrence cycle of the uplink basic time scheduling units.

15. The method for resource determination according to claim 10, further comprising:
receiving the full configuration mode from the network-side device; and
determining, based on the full configuration mode, the consecutive time-domain resources repeated in the first periodicity,
wherein the full configuration mode comprises:
a periodicity parameter, used to describe the first periodicity; or
a resource structure parameter, used to describe a structure of the consecutive time-domain resources; or
a resource configuration parameter, used to describe configuration information about forming the consecutive time-domain resources.

16. (canceled)

17. The method for resource determination according to claim 10, wherein the consecutive time-domain resources repeated in the first periodicity and corresponding to the full configuration mode are pre-agreed by the network-side device with the device at the receiving side, or
the method further comprises:
selecting the consecutive time-domain resources as the radio transmission resources for interaction with the device at a network side, when no resource indication information has been received from the network-side device, or when transmission result indication information is received from the network-side device, and the transmission result indication information indicates that no resource indication information has been transmitted.

18. (canceled)

19. A device for resource indication, applied in a network-side device, comprising: a processor, a memory and a transmitter, wherein the processor is configured to generate resource indication information by calling and executing programs and data stored in the memory; and
the transmitter is configured to transmit resource indication information to a device at a receiving side, wherein the resource indication information is used to indicate the device at the receiving side to determine, from consecutive time-domain resources repeated in a first periodicity and corresponding to a full configuration mode, a part or all of the time-domain resources as radio transmission resources for interaction with the network-side device.

20. The device for resource indication according to claim 19, wherein the resource indication information is used to indicate quantity information and location information related to the radio transmission resources, and wherein the radio transmission resources are continuously distributed in a time domain, and wherein the resource indication information comprises a location of a starting point of the radio transmission resources in the consecutive time-domain resources and the quantity of basic time scheduling units contained in the radio transmission resources.

21-22. (canceled)

23. The device for resource indication according to claim 19, wherein the first periodicity is a repeat cycle of radio frames in a mobile communication system, a repeat cycle of uplink basic time scheduling units in a TDD mobile communication system, a repeat cycle of a synchronization signal in a mobile communication system, or an occurrence cycle of the uplink basic time scheduling units; or
the transmitter is configured to transmit the full configuration mode to the device at the receiving side, wherein the full configuration mode is used for the device at the receiving side to determine the consecutive time-domain resources repeated in the first periodicity; and
wherein the full configuration mode comprises:
a periodicity parameter, used to describe the first periodicity; or
a resource structure parameter, used to describe a structure of the consecutive time-domain resources; or
a resource configuration parameter, used to describe configuration information about forming the consecutive time-domain resources.

24-25. (canceled)

26. The device for resource indication according to claim 19, wherein the consecutive time-domain resources repeated in a first periodicity and corresponding to the full configuration mode are pre-agreed by the network-side device with the device at the receiving side; and
the transmitter is configured to transmit transmission result indication information to the device at the receiving side, to indicate the device at the receiving side whether to receive the resource indication information, wherein the transmission result indication information is used to indicate whether the resource indication information has been transmitted.

27. (canceled)

28. A device for resource determination, applied in a device at a receiving side, configured to implement the method according to claim 10, comprising: a processor, a memory and a receiver,
wherein the processor is configured to, by calling and executing programs and data stored in the memory, determine, based on resource indication information, a part or all of time-domain resources from consecutive time-domain resources repeated in a first periodicity and corresponding to a full configuration mode, as radio transmission resources for interaction with a network-side device, when the resource indication information is received from the network-side device by the receiver.

29. The device for resource determination according to claim 28, wherein the resource indication information is used to indicate quantity information and location information related to the radio transmission resources;
wherein the radio transmission resources are continuously distributed in a time domain; and
wherein the resource indication information comprises a location of a starting point of the radio transmission resources in the consecutive time-domain resources and the quantity of basic time scheduling units contained in the radio transmission resources.

30-31. (canceled)

32. The device for resource determination according to claim 28, wherein the first periodicity is a repeat cycle of radio frames in a mobile communication system, a repeat cycle of uplink basic time scheduling units in a TDD mobile communication system, a repeat cycle of a synchronization signal in the mobile communication system, or an occurrence cycle of the uplink basic time scheduling units; or
wherein the receiver is configured to receive the full configuration mode from the network-side device; and the processor is configured to determine the consecutive time-domain resources repeated in the first periodicity based on the full configuration mode; and
wherein the full configuration mode comprises:
a periodicity parameter, used to describe the first periodicity; or
a resource structure parameter, used to describe a structure of the consecutive time-domain resources; or
a resource configuration parameter, used to describe configuration information about forming the consecutive time-domain resources.

33-34. (canceled)

35. The device for resource determination according to claim 28, wherein the consecutive time-domain resources repeated in the first periodicity and corresponding to the full configuration mode are pre-agreed by the network-side device and the device at the receiving side; and
the processor is configured to select the consecutive time-domain resources as the radio transmission resources for interaction with the device at the network side, when no resource indication information has been received by the receiver from a network-side device, or when transmission result indication information is received by the receiver from the network-side device, and the transmission result indication information indicates that no resource indication information has been transmitted.

36-42. (canceled)
